(19) United States
(12) Patent Application Publication
(10) Pub. No.: US 2020/0018551 A1
(43) Pub. Date: Jan. 16, 2020

(54) ARTIFICIAL INTELLIGENCE COOKING DEVICE

(71) Applicant: LG ELECTRONICS INC., Seoul (KR)

(72) Inventors: Jinyoung HUR, Seoul (KR); Jeongtae KIM, Seoul (KR); Taewon JANG, Seoul (KR)

(73) Assignee: LG ELECTRONICS INC., Seoul (KR)

(21) Appl. No.: 16/581,142

(22) Filed: Sep. 24, 2019

(30) Foreign Application Priority Data
Aug. 12, 2019 (KR) 10-2019-0098468

(51) Int. Cl. F27D 21/02; A23L 5/10; F24C 7/08

(52) U.S. Cl. CPC F27D 21/02; A23L 5/15; F27D 2021/026; A23V 2002/00; F24C 7/085

(57) ABSTRACT

Disclosed in an artificial intelligence cooking device. The artificial intelligence cooking device according to an embodiment includes: a sensing unit configured to photograph at least one food material and detect a distance to the at least one food material; and a processor configured to acquire a weight of the at least one food material by providing an image obtained by photographing the at least one food material and the detected distance to an artificial intelligence model, and perform cooking according to a cooking course that is set on the basis of a kind of the at least one food material and the weight of the at least one food material. Here, the artificial intelligence model is a neural network that is trained by using training data including an image obtained by photographing a food material and a distance from which an image is photographed and labeling data including a weight of a food material.

### CROSS-REFERENCE TO RELATED APPLICATIONS

The present application claims priority under 35 U.S.C. 119 and 35 U.S.C. 365 to Korean Patent Application No. 10-2019-0098468 filed on Aug. 12, 2019 in Korea, which is hereby incorporated by reference in its entirety.

### BACKGROUND

The present disclosure herein relates to an artificial intelligence cooking device capable of photographing an image of a food material to determine a weight of the food material and setting a cooking course according to the determined weight.

Artificial intelligence is one field of a computer engineering and information technology, which researches a method for allowing a computer to perform thinking, learning, or self-development that is, the artificial intelligence allows a computer to imitate an intelligent behavior of a human.

Also, the artificial intelligence does not exist by itself, but has many relationships with other fields of a computer science in a direct or indirect manner. In recent years, various fields of the information technology have been actively tried to adopt and utilize an artificial intelligence feature in problem solving.

Also, a technology that recognizes and learns a surrounding situation and provide information in a user-desired type or performs a user-desired operation or function has been actively researched.

Also, an electronic device providing the above described all sorts of operations and functions may be referred to as an artificial intelligence device.

Here, an electronic device such as an oven and a microwave oven sets a cooking course such as a cooking temperature and a cooking time and cooks foods according to the set cooking course.

However, even the same kinds of food materials may be different in size, and as the sizes of the food materials are varied, the cooking temperature and the cooking time may be different. For example, a small chicken may be completely cooked when heated in an oven for 30 minutes, but a large chicken may be completely cooked when heated in an oven for 50 minutes.

Typically, the cooking time is set in such a manner that a user directly input. However, since the above method is able to be performed when the user knows the cooking time (or cooking temperature) according to the size of the food material, the method may cause inconvenience to the user, and the cooking may not be properly performed by inputting an incorrect cooking time (or cooking temperature).

### SUMMARY

The present disclosure provide an artificial intelligence cooking device capable of photographing an image of a food material to determine a weight of the food material and setting a cooking course according to the determined weight.

Embodiments provide an artificial intelligence cooking device including: a sensing unit configured to photograph at least one food material and detect a distance to the at least one food material; and a processor configured to acquire a weight of the at least one food material by providing an image obtained by photographing the at least one food material and the detected distance to an artificial intelligence model, and perform cooking according to a cooking course that is set on the basis of a kind of the at least one food material and the weight of the at least one food material. Here, the artificial intelligence model is a neural network that is trained by using training data including an image obtained by photographing a food material and a distance from which an image is photographed and labeling data including a weight of a food material.

### BRIEF DESCRIPTION OF THE DRAWINGS

FIG. 1 is a view illustrating an AI device 100 according to an embodiment.

FIG. 2 is a view illustrating an AI server 200 according to an embodiment.

FIG. 3 is a view illustrating an AI system 1 according to an embodiment.

FIGS. 4 to 6 are views for explaining an artificial intelligence cooking device according to an embodiment.

FIG. 7 is a flowchart for explaining a method for operating an artificial intelligence cooking device according to an embodiment.

FIG. 8 is a view for explaining a method for generating an artificial intelligence model according to an embodiment.

FIG. 9 is a view for explaining a method for photographing a food material and detecting a distance of the food material according to an embodiment.

FIG. 10 is a view for explaining a method for acquiring a weight of a food material and setting a cooking course on the basis of the weight of the food material according to an embodiment.

FIG. 11 is a view for explaining a method of setting a cooking course when a plurality of food materials are photographed according to an embodiment.

FIG. 12 is a view for explaining a method of adjusting a ratio between the first food material and the second food material according to an embodiment.

FIG. 13 is a view for explaining a method of calculating a total calorie of a first food material and a second food material according to an embodiment.

FIG. 14 is a view for explaining a method of modifying a cooking course according to an embodiment.

FIG. 15 is a view for explaining a connected operation with a refrigerator according to an embodiment.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

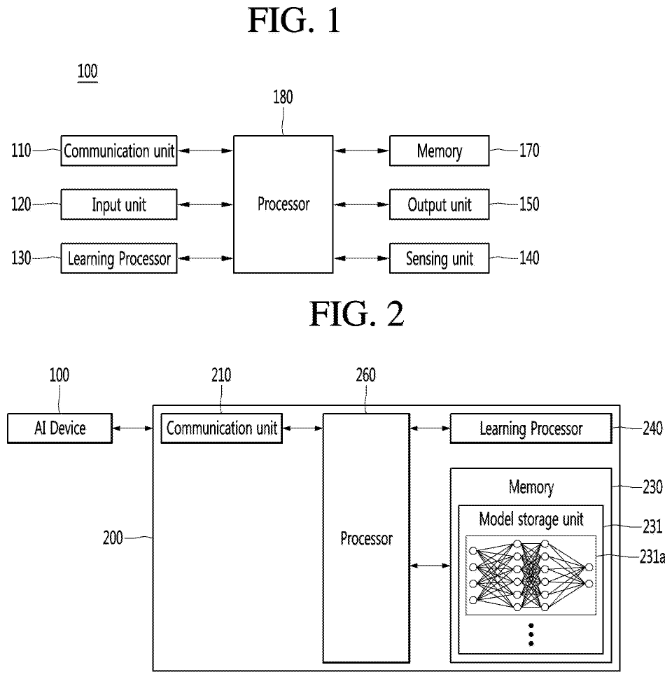

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

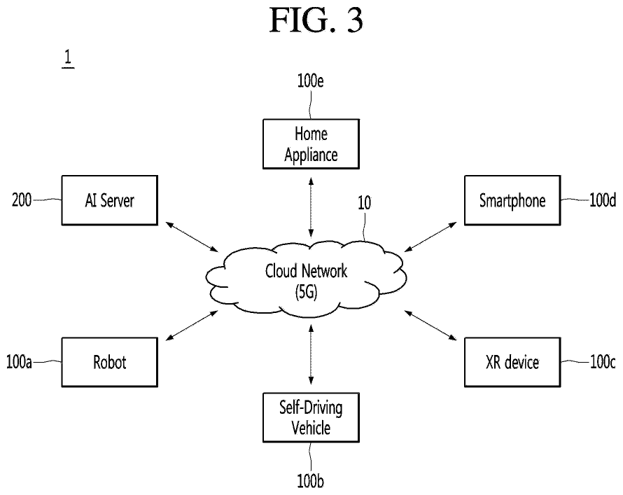

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

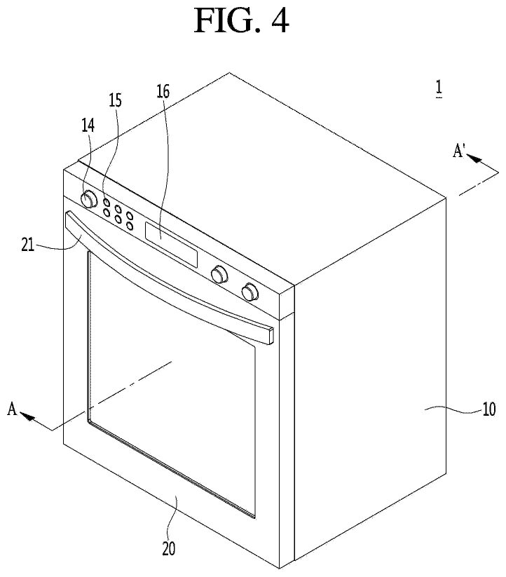

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

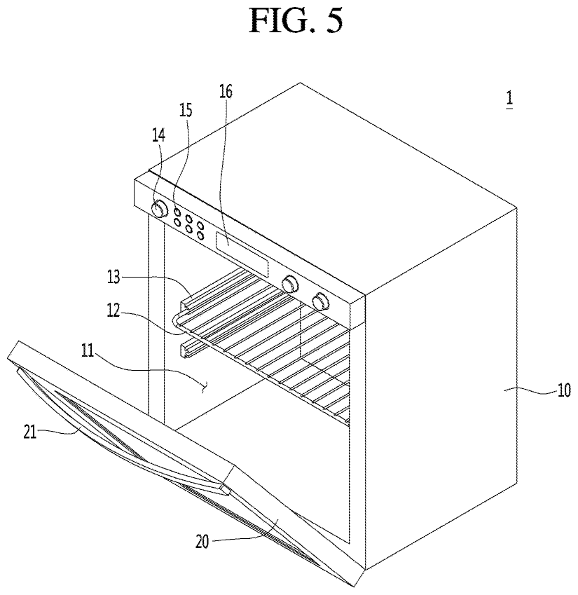

FIGS. 4 to 6 are views for explaining an artificial intelligence cooking device according to an embodiment.

Hereinafter, the artificial intelligence cooking device will be described by using an example of an oven.

In general, the oven is a device for cooking by heating food disposed in a predetermined space. The oven may be classified into an electric type, a gas type, and an electronic type according to a heat source thereof. For example, an electric oven uses an electric heater as a heat source, a gas oven uses heat generated by a gas as a heat source, and an electronic oven (a microwave oven) uses frictional heat of water molecules caused by a high frequency as a heat source.

FIG. 4 is a view illustrating an oven according to an embodiment, and FIG. 5 is a view illustrating a state in which a door of the oven is opened according to an embodiment.

As illustrated in FIGS. 4 to 5, an oven 1 according to an embodiment includes a case 10 providing an appearance and a door 20 attached to one surface of the case 10.

The case 10 has a shape having an inner space and an opened front surface. The case 10 may have a predetermined box shape and include a power unit 14, an input unit 15, and a display unit 16 at an outer side thereof.

The power unit 14 may have various shapes allowing a user to turn on/off a power of the oven 1. Also, the input unit 15 includes a plurality of buttons so that the user may select all sorts of modes, temperatures, and time.

The display unit 16 visualizes predetermined information so that the user may recognize a state of the oven 1. In particular, the display unit 16 may be turned on/off in conjunction with the power unit 14, and have a predetermined panel shape. The display unit 16 will be described in detail later.

A cooking compartment 11 accommodating food is defined in the case 10. A grill 12 on which food is disposed may be provided in the cooking compartment 11. Also, a grill mounting unit 13 may be provided on an inner sidewall of the cooking compartment so that the grill 12 is detachably installed. The grill 12 and the grill mounting unit 13 may be provided in various numbers and shapes.

Also, a heating unit 17, a fan 18, and a fan motor 19 providing a driving force to the fan 18 are disposed in the case 10 and an outer side of the cooking compartment 11. The heating unit 17 heats the inside of the cooking compartment 11, and the fan 18 allows air in the cooking compartment 11 to flow.

The heating unit 17 may be an electric heater emitting heat by electricity input. The heating unit 17 may be disposed at one side of the base 10. Also, the heating unit 17 may be disposed at one side of the fan 18 and integrated with the fan 18. The fan 18 receives a driving force from the fan motor 19 to allow the air in the cooking compartment 11, which is heated by the heating unit 17, to flow.

That is, the heating unit 17 and the fan 18 are provided to cook the food in the cooking compartment 11. However, the embodiment is not limited to the shape in the drawing. For example, each of the heating unit 17 and the fan 18 may have various shapes. Also, the oven 1 according to an embodiment may include an electric-type oven using electricity as a heat source. However, the embodiment is not limited thereto. For example, the oven 1 may cook food with various heat sources such as a gas-type or electronic-type heat source.

The door 20 is disposed at the opened front surface of the case 10 to open and close the cooking compartment 11. That is, the cooking compartment 11 may be opened and closed by the door 20. For convenience of description, a configuration of an installation structure and a locking device of the door 20 will be omitted in illustration.

As illustrated in FIG. 5, the door 20 is disposed at the front surface of the case 10 to rotate in a forward direction. Also, a handle 21, which allows the user to grip and rotate, may be provided to the door 20.

Also, in the oven 1 according to an embodiment, a predetermined sensing unit capable of detecting an inner state of the cooking compartment 11 may be provided. In the sensing unit, a camera 32 capable of photographing the inside of the cooking compartment 11 may be provided. The camera 32 may be disposed at one side of the cooking compartment 11 to provide an image of the inside of the cooking compartment 11.

FIG. 6 is a view illustrating a control configuration of the oven according to an embodiment.

In the oven 1 according to an embodiment, a processor 50 controlling the above-described configuration.

The user may transmit a predetermined command to the processor 50 by using the power unit 14 and the input unit 15. Here, as described above, the power unit 14 and the input unit 15 may be provided at the outer side of the case 11 or in a mobile device 60 of the user.

For example, the processor 50 and the mobile device 60 may be connected through Bluetooth and the like and transceive predetermined information. That is, the user may input a remote command for controlling the oven 1 from a long distance. For example, the user may preheat the oven 1 by using the mobile device 60 and approach the oven 1 to input food therein after the preheating is completed.

Also, the processor 50 may receive information detected by a predetermined sensing unit. The sensing unit may include the above-described camera 32 and a temperature sensor 30 measuring an inner temperature of the cooking compartment 11. In particular, the camera 32 may photograph the inside of the cooking compartment 11 and transmit the generated image to the processor 50, and the temperature sensor 30 may transmit the inner temperature information of the cooking compartment 11 to the processor 50.

Also, a timer 52 measuring a predetermined time may be provided to the processor 50. For example, when cooking begins, the processor 50 may transmit a command to the timer 52 to measure a cooking time or adjust a reservation time for turning-on the power of the oven 1.

The processor 50 may activate the heating unit 17 and supply a power to the fan motor 19 for driving the fan 18.

Also, the processor 50 may transmit predetermined information to the display unit or the mobile device 60 to visualize the predetermined information. For example, the temperature transmitted by the temperature sensor 30 and the cooking time measured by the timer 52 may be visualized.

The display unit includes the above-described case display unit 16 and a door display unit 40. The processor 50 may visualize at least one of information of the case display unit 16, the door display unit 40, and the mobile device 60.

Although the oven is described as an example of the artificial intelligence cooking device, the embodiment is not limited thereto.

For example, the artificial intelligence cooking device described in the embodiment may be applied to all products including a gas oven, an electric oven, a microwave oven, an induction, a hybrid induction, and a highlight induction, which is capable of setting a cooking temperature or a cooking time to heat a food material, thereby performing cooking.

The artificial intelligence cooking device may include a portion or a whole of a configuration of the AI device 100 described in FIG. 1 and perform a function of the AI device 100.

Also, the artificial intelligence cooking device may include a portion or a whole of a configuration of the oven described in FIGS. 4 to 6 and perform a function of the oven.

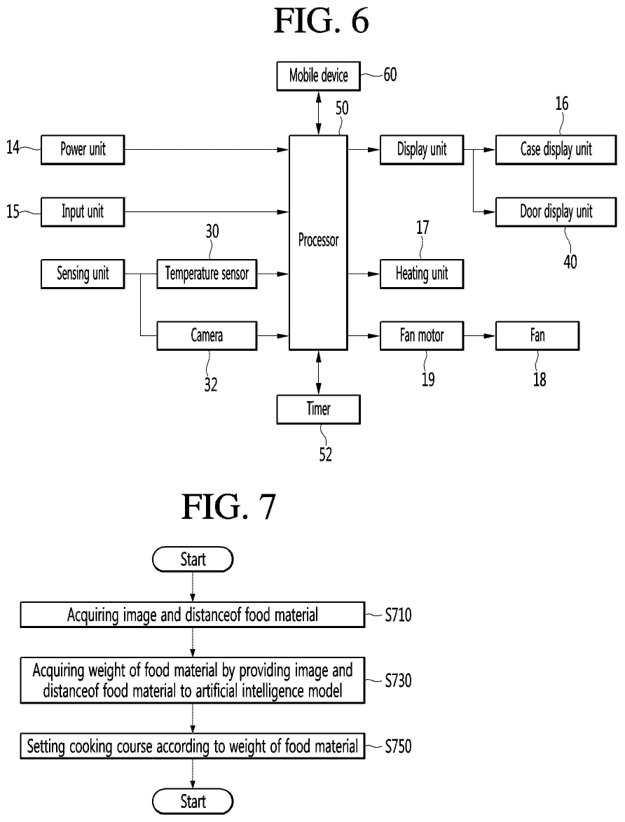

FIG. 7 is a flowchart for explaining a method for operating an artificial intelligence cooking device according to an embodiment.

The method for operating the artificial intelligence cooking device according to an embodiment may include: a process S710 of photographing at least one food material and detecting a distance to at least one food material; a process S730 of acquiring a weight of the food material by providing an image obtained by photographing the at least one food material and the detected distance to an artificial intelligence model; and a process S750 of performing cooking according to a cooking course that is set on the basis of the weight of the food material.

Before embodiments are described in detail, a method for generating an artificial intelligence model will be described.

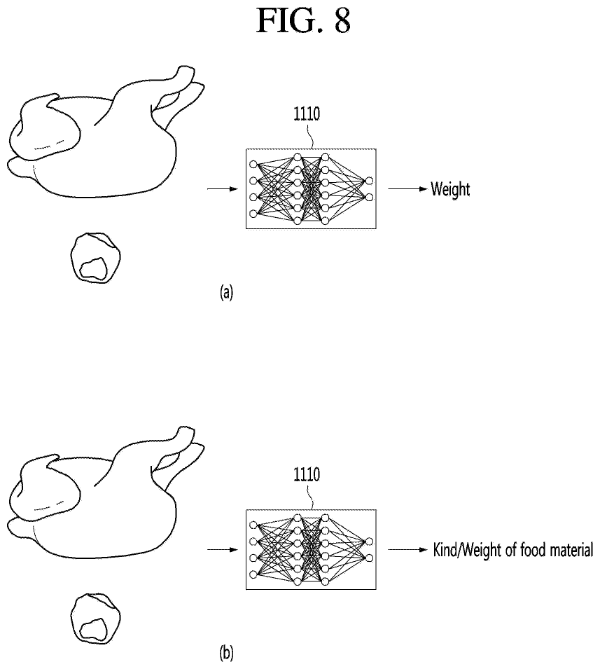

FIG. 8 is a view for explaining a method for generating an artificial intelligence model according to an embodiment.

First, artificial intelligent will be simply described.

Artificial intelligence (AI) is one field of computer engineering and information technology for studying a method of enabling a computer to perform thinking, learning, and self-development that can be performed by human intelligence and may denote that a computer imitates an intelligent action of a human.

Moreover, AI is directly/indirectly associated with the other field of computer engineering without being individually provided. Particularly, at present, in various fields of information technology, an attempt to introduce AI components and use the AI components in solving a problem of a corresponding field is being actively done.

Machine learning is one field of AI and is a research field which enables a computer to perform learning without an explicit program.

In detail, machine learning may be technology which studies and establishes a system for performing learning based on experiential data, performing prediction, and autonomously enhancing performance and algorithms relevant thereto. Algorithms of machine learning may use a method which establishes a specific model for obtaining prediction or decision on the basis of input data, rather than a method of executing program instructions which are strictly predefined.

The term “machine learning” may be referred to as “machine learning”.

In machine learning, a number of machine learning algorithms for classifying data have been developed. Decision tree, Bayesian network, support vector machine (SVM), and artificial neural network (ANN) are representative examples of the machine learning algorithms.

The decision tree is an analysis method of performing classification and prediction by schematizing a decision rule into a tree structure.

The Bayesian network is a model where a probabilistic relationship (conditional independence) between a plurality of variables is expressed as a graph structure. The Bayesian network is suitable for data mining based on unsupervised learning.

The SVM is a model of supervised learning for pattern recognition and data analysis and is mainly used for classification and regression.

The ANN is a model which implements the operation principle of biological neuron and a connection relationship between neurons and is an information processing system where a plurality of neurons called nodes or processing elements are connected to one another in the form of a layer structure.

The ANN is a model used for machine learning and is a statistical learning algorithm inspired from a neural network (for example, brains in a central nervous system of animals) of biology in machine learning and cognitive science.

In detail, the ANN may denote all models where an artificial neuron (a node) of a network which is formed through a connection of synapses varies a connection strength of synapses through learning, thereby obtaining an ability to solve problems.

The term “ANN” may be referred to as “neural network”.

The ANN may include a plurality of layers, and each of the plurality of layers may include a plurality of neurons. Also, the ANN may include a synapse connecting a neuron to another neuron.

The ANN may be generally defined by the following factors: (1) a connection pattern between neurons of a different layer; (2) a learning process of updating a weight of a connection; and (3) an activation function for generating an output value from a weighted sum of inputs received from a previous layer.

The ANN may include network models such as a deep neural network (DNN), a recurrent neural network (RNN), a bidirectional recurrent deep neural network (BRDNN), a multilayer perceptron (MLP), and a convolutional neural network (CNN), but is not limited thereto.

In this specification, the term “layer” may be referred to as “layer”.

The ANN may be categorized into single layer neural networks and multilayer neural networks, based on the number of layers.

General single layer neural networks is configured with an input layer and an output layer.

Moreover, general multilayer neural networks is configured with an input layer, at least one hidden layer, and an output layer.

The input layer is a layer which receives external data, and the number of neurons of the input layer is the same the number of input variables, and the hidden layer is located between the input layer and the output layer and receives a signal from the input layer to extract a characteristic from the received signal and may transfer the extracted characteristic to the output layer. The output layer receives a signal from the hidden layer and outputs an output value based on the received signal. An input signal between neurons may be multiplied by each connection strength (weight), and values obtained through the multiplication may be summated. When the sum is greater than a threshold value of a neuron, the neuron may be activated and may output an output value obtained through an activation function.

The DNN including a plurality of hidden layers between an input layer and an output layer may be a representative ANN which implements deep learning which is a kind of machine learning technology.

The term “deep learning” may be referred to as “deep learning”.

The ANN may be trained by using training data. Here, training may denote a process of determining a parameter of the ANN, for achieving purposes such as classifying, regressing, or clustering input data. A representative example of a parameter of the ANN may include a weight assigned to a synapse or a bias applied to a neuron.

An ANN trained based on training data may classify or cluster input data, based on a pattern of the input data.

In this specification, an ANN trained based on training data may be referred to as a trained model.

Next, a learning method of an ANN will be described.

The learning method of the ANN may be largely classified into supervised learning, unsupervised learning, semi-supervised learning, and reinforcement learning.

The supervised learning may be a method of machine learning for analogizing one function from training data.

Moreover, in analogized functions, a function of outputting continual values may be referred to as regression, and a function of predicting and outputting a class of an input vector may be referred to as classification.

In the supervised learning, an ANN may be trained in a state where a label of training data is assigned.

Here, the label may denote a right answer (or a result value) to be inferred by an ANN when training data is input to the ANN.

In this specification, a right answer (or a result value) to be inferred by an ANN when training data is input to the ANN may be referred to as a label or labeling data.

Moreover, in this specification, a process of assigning a label to training data for learning of an ANN may be referred to as a process which labels labeling data to training data.

In this case, training data and a label corresponding to the training data may configure one training set and may be inputted to an ANN in the form of training sets.

Training data may represent a plurality of features, and a label being labeled to training data may denote that the label is assigned to a feature represented by the training data. In this case, the training data may represent a feature of an input object as a vector type.

An ANN may analogize a function corresponding to an association relationship between training data and labeling data by using the training data and the labeling data. Also, a parameter of the ANN may be determined (optimized) through evaluating the analogized function.

The unsupervised learning is a kind of machine learning, and in this case, a label may not be assigned to training data.

In detail, the unsupervised learning may be a learning method of training an ANN so as to detect a pattern from training data itself and classify the training data, rather than to detect an association relationship between the training data and a label corresponding to the training data.

Examples of the unsupervised learning may include clustering and independent component analysis.

In this specification, the term “clustering” may be referred to as “clustering”.

Examples of an ANN using the unsupervised learning may include a generative adversarial network (GAN) and an autoencoder (AE).

The GAN is a method of improving performance through competition between two different AIs called a generator and a discriminator.

In this case, the generator is a model for creating new data and generates new data, based on original data.

Moreover, the discriminator is a model for recognizing a pattern of data and determines whether inputted data is original data or fake data generated from the generator.

Moreover, the generator may be trained by receiving and using data which does not deceive the discriminator, and the discriminator may be trained by receiving and using deceived data generated by the generator. Therefore, the generator may evolve so as to deceive the discriminator as much as possible, and the discriminator may evolve so as to distinguish original data from data generated by the generator.

The AE is a neural network for reproducing an input as an output.

The AE may include an input layer, at least one hidden layer, and an output layer.

In this case, the number of node of the hidden layer may be smaller than the number of nodes of the input layer, and thus, a dimension of data may be reduced, whereby compression or encoding may be performed.

Moreover, data outputted from the hidden layer may enter the output layer. In this case, the number of nodes of the output layer may be larger than the number of nodes of the hidden layer, and thus, a dimension of the data may increase, and thus, decompression or decoding may be performed.

The AE may control the connection strength of a neuron through learning, and thus, input data may be expressed as hidden layer data. In the hidden layer, information may be expressed by using a smaller number of neurons than those of the input layer, and input data being reproduced as an output may denote that the hidden layer detects and expresses a hidden pattern from the input data.

The semi-supervised learning is a kind of machine learning and may denote a learning method which uses both training data with a label assigned thereto and training data with no label assigned thereto.

As a type of semi-supervised learning technique, there is a technique which infers a label of training data with no label assigned thereto and performs learning by using the inferred label, and such a technique may be usefully used for a case where the cost expended in labeling is large.

The reinforcement learning may be a theory where, when an environment where an agent is capable of determining an action to take at every moment is provided, the best way is obtained through experience without data.

The reinforcement learning may be performed by a Markov decision process (MDP).

To describe the MDP, firstly an environment where pieces of information needed for taking a next action of an agent may be provided, secondly an action which is to be taken by the agent in the environment may be defined, thirdly a reward provided based on a good action of the agent and a penalty provided based on a poor action of the agent may be defined, and fourthly an optimal policy may be derived through experience which is repeated until a future reward reaches a highest score.

An artificial neural network may have a structure that is characterized by a constitution of a model, an activation function, a loss function or a cost function, a learning algorithm, and an optimization algorithm, and include a content that is characterized such that a hyperparameter is preset before learning, and thereafter, a model parameter is set through learning.

For example, a factor determining the structure of the artificial neural network may include the number of hidden layers, the number of hidden nodes contained in each of the hidden layers, an input feature vector, and a target feature vector.

The hyperparameter includes various parameters such as an initial value of the model parameter, which are required to be initially set for learning. Also, the model parameter includes various parameters to be determined through learning.

For example, the hyperparameter includes a weight initial value between nodes, a biased initial value between nodes, a mini-batch size, the repeated number of learning, and a learning rate. Also, the model parameter may include weight between nodes and bias between nodes.

The loss function can be used for an index (reference) for determining optimum model parameters in a training process of an artificial neural network. In an artificial neural network, training means a process of adjusting model parameters to reduce the loss function and the object of training can be considered as determining model parameters that minimize the loss function.

Although the loss function may generally use a mean squared error (MSE) or a cross entropy error (CEE), the embodiment is not limited thereto.

The CEE may be used when a correct answer label is one-hot encoded. One-hot encoding is an encoding method for setting a correct answer label value to 1 for only neurons corresponding to a correct answer and setting a correct answer label to 0 for neurons corresponding to a wrong answer.

A learning optimization algorithm may be used to minimize a loss function in machine learning or deep learning, as the learning optimization algorithm, there are Gradient Descent (GD), Stochastic Gradient Descent (SGD), Momentum, NAG (Nesterov Accelerate Gradient), Adagrad, AdaDelta, RMSProp, Adam, and Nadam.

The GD is a technique that adjusts model parameters such that a loss function value decreases in consideration of the gradient of a loss function in the current state.

The direction of adjusting model parameters is referred to as a step direction and the size of adjustment is referred to as a step size.

Here, the step size may refer to a learning rate.

The GD may acquire a gradient by partially differentiating the loss function by each of the model parameters, and update the model parameters by changing the model parameters as much as the learning rate in a gradient direction

The SGD is a technique that increases the frequency of gradient descent by dividing training data into mini-batches and performing the GD for each of the mini-batches.

The Adagrad, AdaDelta, and RMSProp in the SGD are techniques that increase optimization accuracy by adjusting the step size. The momentum and the NAG in the SGD are techniques that increase optimization accuracy by adjusting the step direction. The Adam is a technique that increases optimization accuracy by adjusting the step size and the step direction by combining the momentum and the RMSProp. The Nadam is a technique that increases optimization accuracy by adjusting the step size and the step direction by combining the NAG and the RMSProp.

The learning speed and accuracy of an artificial neural network greatly depends on not only the structure of the artificial neural network and the kind of a learning optimization algorithm, but the hyperparameters. Accordingly, in order to acquire a good trained model, it is important not only to determine a suitable structure of an artificial neural network, but also to set suitable hyperparameters.

In general, hyperparameters are experimentally set to various values to train an artificial neural network, and are set to optimum values that provide stable learning speed and accuracy using training results.

The artificial intelligence model according to an embodiment may be a neural network that is trained by using training data including an image obtained by photographing a food material and a distance from which an image is photographed and labeling data including a weight of a food material.

First, a method for training the neural network to predict a weight of a food material with reference to FIG. 8A.

The learning device 200 may train a neural network 1110 by labeling the weight of the food material to the training data including the image obtained by photographing the food material and the distance from which the image is photographed.

In particular, the learning device 200 may acquire the image obtained by photographing the food material and the distance from which the image is photographed (i.e., distance between the camera and the food material).

Also, the learning device 200 may train the neural network by using the image obtained by photographing the food material and the distance from which the image is photographed as an input value and the weight of the photographed food material as an output value.

Here, the weight of the food material may be inferred by the neural network using the image obtained by photographing the food material and the distance from which the image is photographed.

Thus, the learning device 200 may label the labeling data including the weight of the food material to the training data including the image obtained by photographing the food material and the distance from which the image is photographed, and provide the data to the neural network.

In this case, the neural network may infer a relationship between ‘the image obtained by photographing the food material and the distance from which the image is photographed’ and the weight of the food material by using the training data and the labeling data. Also, the parameter (weight, bias, etc.) of the neural network may be determined (optimized) through an evaluation on the function inferred from the neural network.

The learning device 200 may train the neural network by using the images obtained by photographing various kinds of food materials at various distances and weights of the food materials.

For example, when an image obtained by photographing a chicken of 3 kg at a distance of 1 m, the learning device 200 may provide the image obtained by photographing the chicken of 3 kg at the distance of 1 m and an input value of 1 m to the neural network, and provide an output value of 3 kg to the neural network.

For another example, when an image obtained by photographing a chicken of 3 kg at a distance of 1 m, the learning device 200 may provide the image obtained by photographing the chicken of 3 kg at the distance of 1 m and an input value of 1 m to the neural network, and provide an output value of 3 kg to the neural network.

Although the labeling data is described as a weight in the previous description, the embodiment is not limited thereto. For example, the label data may be a kind and a weight of a food material.

In particular, the artificial intelligence model according to an embodiment may be a neural network that is trained by using training data including an image obtained by photographing a food material and a distance from which an image is photographed and labeling data including a kind and a weight of a food material.

Particularly, the learning device 200 may train a neural network 1110 by labeling the kind and the weight of the food material to the training data including the image obtained by photographing the food material and the distance from which the image is photographed.

More particularly, the learning device 200 may acquire the image obtained by photographing the food material and the distance from which the image is photographed (i.e., distance between the camera and the food material).

Also, the learning device 200 may train the neural network by using the image obtained by photographing the food material and the distance from which the image is photographed as an input value and the kind and the weight of the photographed food material as an output value.

Here, the kind and the weight of the food material may be inferred by the neural network using the image obtained by photographing the food material and the distance from which the image is photographed.

Also, the neural network may infer a function of a relationship between ‘the image obtained by photographing the food material and the distance from which the image is photographed’ and ‘the kind and weight of the food material’ by using the training data and the labeling data. Also, parameters (weight, bias, etc.) of the neural network may be determined (optimized) through an evaluation on the function inferred from the neural network.

The learning device 200 may train a neural network by using images obtained by photographing various kinds of food materials from various distances and the weight of the food material.

For example, when an image obtained by photographing a chicken having a weight of 3 kg from a distance of 1 m exists, the learning device 200 may provide the image obtained by photographing the chicken having a weight of 3 kg from the distance of 1 m and the 1 m as an input value, and the 3 kg and the chicken as an output value to the neural network.

For another example, when an image obtained by photographing a potato having a weight of 200 g from a distance of 30 cm exists, the learning device 200 may provide the image obtained by photographing the potato having a weight of 200 g from the distance of 30 cm and the 30 cm as an input value, and the 200 g and the potato as an output value to the neural network.

The neural network trained in the above-described method may be referred to as an artificial intelligence model.

The artificial intelligence model may be mounted to the artificial intelligence cooking device.

Particularly, the artificial intelligence model may be realized by hardware, software, or a combination thereof. Also, when a portion or a whole of the artificial intelligence model is realized by software, at least one command of the artificial intelligence model may be stored in the memory of the artificial intelligence cooking device.

The artificial intelligence model may be mounted to a server, and, in this case, the artificial intelligence cooking device may communicate with the server to acquire the weight of the food material.

That is, in this specification, a feature of acquiring a weight of at least one food material by providing an image obtained by photographing at least one food material and a distance to the artificial intelligence model may represent that the artificial intelligence cooking device inputs the image obtained by photographing at least one food material and the distance to the artificial intelligence model mounted to the artificial intelligence cooking device and acquire an output value outputted by the artificial intelligence model, or represent that the artificial intelligence cooking device transmits the image obtained by photographing at least one food material and the distance to the server and receive the output value outputted by the artificial intelligence model from the server.

Also, in this specification, a feature of acquiring a cooking course may represent that a cooking course corresponding to the kind and weight of the food material is determined by using information stored in the memory of the artificial intelligence cooking device, or represent that related information is transmitted to the server, the server determines a cooking course corresponding to the kind and weight of the food material by using information stored in the memory of the server, and the determined cooking course is received from the server.

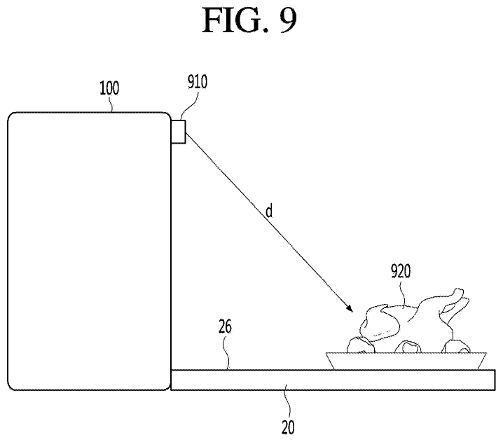

FIG. 9 is a view for explaining a method for photographing a food material and detecting a distance of the food material according to an embodiment.

The sensing unit 140 of the artificial intelligence cooking device 100 may include a camera 910. Here, the camera 910 may be disposed on a front surface of the artificial intelligence cooking device 100 to photograph a front side of the artificial intelligence cooking device 100.

When a door 20 is opened, a food material or a container filled with a food material may be disposed on an inner plate 26 contacting the cooking compartment.

Also, the camera 910 may be disposed toward the inner plate 26 to photograph the food material or the container disposed on the inner plate 26.

The camera 910 may photograph at least one food material.

Here, at least one food material may be photographed individually or in batches.

Particularly, when a plurality of food materials are individually inputted to the cooking compartment, the processor may acquire a plurality of images obtained by photographing the plurality of food materials, respectively. Also, when the plurality of food materials are stored in one container and inputted to the cooking compartment at once, the processor may acquire one image obtained by photographing the plurality of food materials.

The sensing unit may detect a distance d of at least one food material. Here, the distance d of at least one material 920 may represent a distance d between the camera 910 and the food material 920.

For this, a currently well-known device or algorithm for measuring a distance to an object may be directly applied.

For example, the sensing unit 140 may include a distance sensor such as a time of flight (TOF) camera, and the processor may measure a time in which light arrives at a food material and is reflected and returned to measure the distance d of the food material 920.

Also, the processor 180 may acquire a weight of at least one food material by providing the image obtained by photographing at least one food material and the distance to the artificial intelligence model.

First, an operation when one food material is photographed will be described.

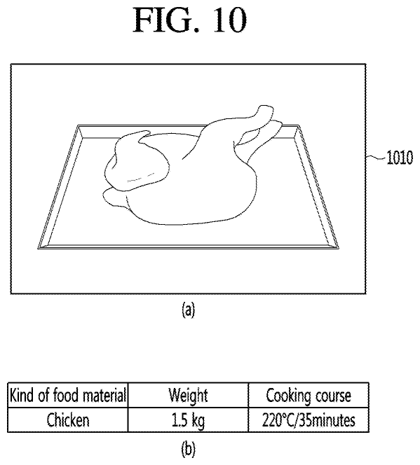

FIG. 10 is a view for explaining a method for acquiring a weight of a food material and setting a cooking course on the basis of the weight of the food material according to an embodiment.

The processor 180 may acquire a weight of a food material by providing an image 1010 obtained by photographing the food material to the artificial intelligence model.

Particularly, the processor 180 may provide the image 1010 obtained by photographing the food material to the artificial intelligence model. Here, the artificial intelligence model may be a neural network that is trained by using the weight of the food material as labeling data. In this case, the artificial intelligence model may output a result value, specifically the weight of the food material.

The processor 180 may acquire the kind of the food material.

Particularly, the processor 180 may recognize the food material of the image 1010 and determine the kind of the food material according to a recognition result. For example, when the image 1010 includes a chicken, the processor may determine an object of the image 1010 as a chicken through an object recognition. For this, a currently well-known object recognition method may be directly applied.

Also, the processor 180 may acquire the kind and weight of the food material by providing the image 1010 obtained by photographing the food material to the artificial intelligence model.

Particularly, the processor 180 may provide the image 1010 obtained by photographing the food material to the artificial intelligence model. Here, the artificial intelligence model may be a neural network that is trained by using the kind and weight of the food material as labeling data. In this case, the artificial intelligence model may output a result value, specifically the kind and weight of the food material.

The processor may determine a cooking course on the basis of the kind and weight of the food material.

Here, the cooking course may include at least one of a cooking temperature or a cooking time. Also, the processor may determine at least one of the cooking temperature or the cooking time according to the kind and weight of the food material.

For example, when the food material is a chicken having a weight of 1.5 kg, the processor may set a cooking temperature of 220° C. and a cooking time of 35 minutes.

For another example, when the food material is a chicken having a weight of 1.0 kg, the processor may set a cooking temperature of 220° C. and a cooking time of 30 minutes.

For another example, when the food material is a pork having a weight of 2.0 kg, the processor may set a cooking temperature of 200° C. and a cooking time of 50 minutes.

In a memory, a table corresponding to cooking courses and various weight of various food materials may be stored. Also, the processor may set a cooking course on the basis of the kind of the food material, the weight of the food material, and the table stored in the memory.

Also, the processor may perform cooking according to a set cooking course. For example, when a cooking course having a cooking temperature of 200° C. and a cooking time of 50 minutes is set, the processor may drive a heating unit to apply heat to the food material for 50 minutes at a cooking temperature of 200° C.

According to an embodiment, a cooking optimized to the kind and size of the food material may be performed without directly inputting a cooking time by the user.

Also, according to an embodiment, an optimized cooking may be performed by calculating the weight of the food material through a simple method of photographing the food material before the food material is inputted into the cooking device.

Next, a method of setting a cooking course by using one image obtained by photographing a plurality of food materials.

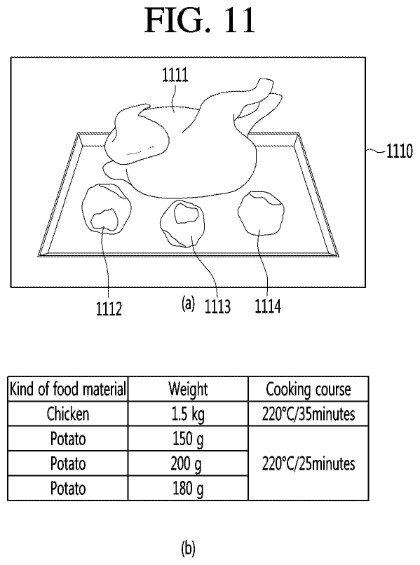

FIG. 11 is a view for explaining a method of setting a cooking course when a plurality of food materials are photographed according to an embodiment.

Hereinafter, terms of a “first food material” and a “second food material” may represent food materials that are different in kind from each other. For example, the first food material may be a chicken, and the second food material may be a potato.

Also, terms of a “2-1 food material”, a “2-2 food material”, and a “2-3 food material” may represent food materials that are same in kind and different in entity. For example, the 2-1 food material may represent a first potato, the 2-2 food material may represent a second potato, and the 2-3 food material may represent a third potato.

Also, hereinafter, a term of a “weight of a second food material” may represent a total weight of entities having the same kind as each other. Particularly, the “weight of the second food material” may represent a total weight of a weight of the “2-1 food material”, a weight of the “2-2 food material”, and a weight of the “2-3 food material”.

The processor 180 may provide an image 1110 obtained by photographing a plurality of food material 1111, 1112, 1113, and 1114 to the artificial intelligence model and acquire a weight of the plurality of food materials.

Particularly, the processor 180 may provide the image 1110 obtained by photographing the plurality of food material 1111, 1112, 1113, and 1114 to the artificial intelligence model. Here, the artificial intelligence model may be a neural network that is trained by using the weight of the food material as the labeling data. In this case, the artificial intelligence model may output a weight of a first food material 1111, a weight of a second-first food material 1112, a weight of a second-second food material 1113, and a weight of a second-third food material 1114.

The processor 180 may acquire the kind of the food material.

Particularly, the processor 180 may recognize a plurality of food materials of the image 1110 and determine the kind of the plurality of food materials according to a recognition result. For example, the processor may determine the first food material 1111 as a chicken and the second-first, second-second, and second-third food materials 1112, 1113, and 1114 as potatoes.

Also, the processor 180 may acquire the kind and weight of the plurality of food materials by providing the image 1110 obtained by photographing the plurality of food materials.

Particularly, the processor 180 may provide the image 1110 obtained by photographing the plurality of food materials to the artificial intelligence model. Here, the artificial intelligence model may be a neural network that is trained by using the kind and weight of the food material as the labeling data. In this case, the artificial intelligence model may output the kind and weight of the first food material 1111, the kind and weight of the second-first food material 1112, the kind and weight of the second-second food material 1113, and the kind and weight of the second-third food material 1114.

Also, the processor may separate the image 1110 obtained by photographing the plurality of food materials and individually provide a plurality of images to the artificial intelligence model.

Particularly, the processor may separate the image 1110 obtained by photographing the plurality of food materials into an image including the first food material 1111 of the plurality of food materials, an image including the second-first food material 1112 of the plurality of food materials, an image including the second-second food material 1113 of the plurality of food materials, and an image including the second-third food material 1114 of the plurality of food materials.

Also, the processor may acquire the weight of the first food material (or, the kind and weight of the first food material) by providing the image including the first food material 1111 to the artificial intelligence model, acquire the weight of the second-first food material (or, the kind and weight of the second-first food material) by providing the image including the second-first food material 1112 to the artificial intelligence model, acquire the weight of the second-second food material (or, the kind and weight of the second-second food material) by providing the image including the second-second food material 1113 to the artificial intelligence model, and acquire the weight of the second-third food material (or, the kind and weight of the second-third food material) by providing the image including the second-third food material 1114 to the artificial intelligence model.

Also, the processor may acquire a weight of the second food material. Particularly, the processor may calculate the weight of the second food material by adding all of the weights of the second-first food material, second-second food material, and second-third food material.

Also, the processor may determine a cooking course by using the kind and weight of the first food material and the kind and weight of the second food material.

Particularly, the processor may acquire a first cooking course by using the kind and weight of the first food material. For example, the processor may acquire a cooking course corresponding to a chicken having a weight of 1.5 kg.

Also, the processor may acquire a second cooking course by using the kind and weight of the second food material. For example, the processor may acquire a cooking course corresponding to a potato having a weight of 530 g.

Here, the first cooking course and the second cooking course may be different from each other. For example, the first cooking course corresponding to the chicken having a weight of 1.5 kg may have a cooking temperature of 220° C. and a cooking time of 35 minutes, and, the second cooking course corresponding to the potato having a weight of 530 g may have a cooking temperature of 220° C. and a cooking time of 25 minutes.

Also, when the first cooking course and the second cooking course are different, the processor may perform the first cooking course having a longer cooking time among the first cooking course and the second cooking course.

For another example, when the first cooking course and the second cooking course are different, the processor may perform the first cooking course having a higher cooking temperature among the first cooking course and the second cooking course.

That is, according to an embodiment, when different kinds of food materials have different cooking courses, a cooking course having a longer cooking time or a higher cooking temperature may be selected to cook all food materials.

When the first cooking course and the second cooking course are different, the processor may output a notice.

Particularly, when first cooking course and the second cooking course are different, the processor may control the display unit to display a notice that a plurality of food materials are inappropriate to be cooked together or output a voice that a plurality of food materials are inappropriate to be cooked together through the speaker.

For example, the processor may output a notice of “since a chicken and a potato are inappropriate to be cooked together, please cook separately!”.

Also, the processor may output a notice of putting a first food material first when a cooking time corresponding to a first cooking course is a first time, and a cooking time corresponding to a second cooking course is a second time shorter than the first time.

For example, when the cooking time of the first cooking course is 35 minutes, and the cooking time of the second cooking course is 25 minutes, a notice of putting a chicken first, which corresponds to the first cooking course.

In this case, the user may remove the potato from the container and put the chicken into the artificial intelligence cooking device. Then, the processor may perform a cooking according to the first cooking course.

When the cooking time according to the first cooking course remains the second time, the processor may output a notice of putting the second food material.

Particularly, the processor may check a remained cooking time of the first cooking course while the cooking is performed according to the first cooking course. Also, when the remained cooking time of the first cooking course is the second time, the processor may output a notice of putting the second food material.

For example, when the cooking time of the first cooking course is 35 minutes, and the cooking time of the second cooking course is 25 minutes, the processor may perform the cooking according to the first cooking course. When the remained cooking time of the first cooking course is 25 minutes, the processor may output a notice of temporarily stopping the cooking and putting the second food material.

In this case, the user may additionally put the potato into the cooking device.

Thereafter, the processor may perform the cooking according to the first cooking course. Particularly, the processor may perform the cooking according to the first cooking course during the remained cooking time.

As described above, according to an embodiment, an optimized cooking may be performed in consideration of even the weights of the different kinds of food materials.

The processor may perform the cooking according to the first cooking course with respect to the put first and second food materials when the cooking time corresponding to the first cooking course is a first time, and the cooking time corresponding to the second cooking course is a second time shorter than the first time.

For example, when the cooking time of the first cooking course is 35 minutes and the cooking time of the second cooking course is 25 minutes, and the first and second food materials are put into the artificial intelligence cooking device, the processor may perform the cooking according to the first cooking course.

When the second time elapses since the cooking according to the first cooking course is performed, the processor may output a notice of removing the second food material.

Particularly, while the cooking according to the first cooking course is performed, the processor may check the cooking time according to the first cooking course. When the cooking time according to the first cooking course is the second time, the processor may output a notice of removing the second food material.

For example, when the cooking time of the first cooking course is 35 minutes and the cooking time of the second cooking course is 25 minutes, the processor may perform the cooking according to the first cooking course. Also, when the cooking time of the first cooking course is 25 minutes, the processor may output a notice of temporarily stopping the cooking and removing the second food material.

In this case, the user may take out the potato from the cooking device.

Thereafter, the processor may perform the cooking according to the first cooking course. Particularly, the processor may perform the cooking according to the first cooking course during the remained cooking time.

As described above, according to an embodiment, the optimized cooking may be performed in consideration of even the weights of the different kinds of food materials.

Particularly, according to an embodiment, when all of different kinds of food materials are put into the cooking device at once, the artificial intelligence cooking device may automatically calculate a weight of each of the different kinds of food materials, and cook the different kinds of food materials in an optimized method according to the calculated weight.

Thereafter, a method of adjusting a ratio between the first food material and the second food material will be described.

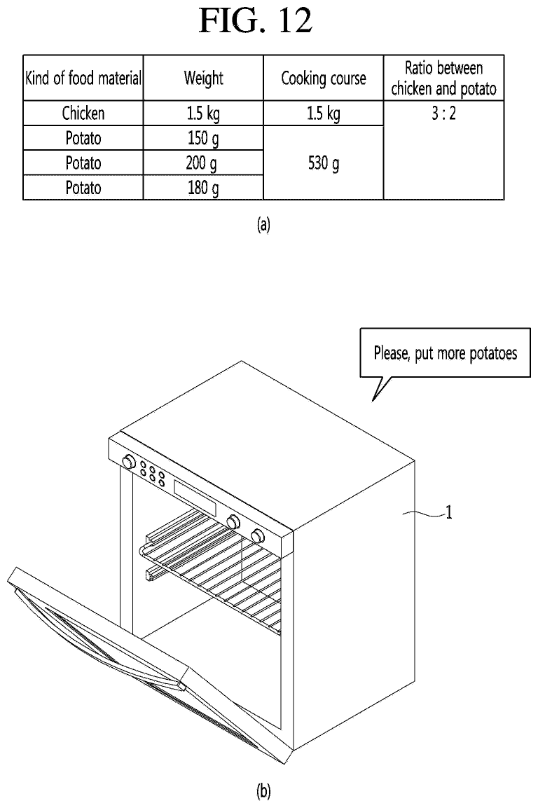

FIG. 12 is a view for explaining a method of adjusting a ratio between the first food material and the second food material according to an embodiment.

The ratio between the first food material and the second food material may be stored in the memory.

Here, the ratio between the first food material and the second food material may be determined in terms of dietetics.

For example, when the first food material is a chicken and the second food material is a potato, a ratio between weights of the chicken and the potato may be determined so that the user ingests protein, fat, and carbohydrate in a balanced manner.

For example, a ratio between the chicken and the potato (specifically, a ratio between the weight of the chicken and the weight of the potato) may be 3:2.

The processor may output a notice for recommending additional input or removal of one of the first food material and the second food material on the basis of the weights of the first food material and the second food material and the ratio between the first food material and the second food material.

For example, when the weight of the chicken that is the first food material is 1.5 kg, and the weight of the potato that is the second food material is 530 g, a ratio between the photographed chicken and potato may be different from a ratio between the chicken and the potato stored in the memory.

Also, when the ratio between the photographed chicken and potato is the same as the ratio between the chicken and potato stored in the memory by additionally inputting the potato, the processor may output a notice of additionally inputting the potato.

For another example, when the ratio between the photographed chicken and potato is the same as the ratio between the chicken and potato stored in the memory by removing the potato, the processor may output a notice of removing the potato.

As described above, according to an embodiment, the user may have a well-balanced meal in terms of dietetics.

Particularly, according to an embodiment, when different kind of food materials are put into the cooking device at once, the artificial intelligence cooking device may automatically calculate a weight of each of the different kinds of food materials and provide a well-balanced meal in terms of dietetics according to the calculated weight.

Next, a method of calculating a total calorie when different kinds of food materials are inputted.

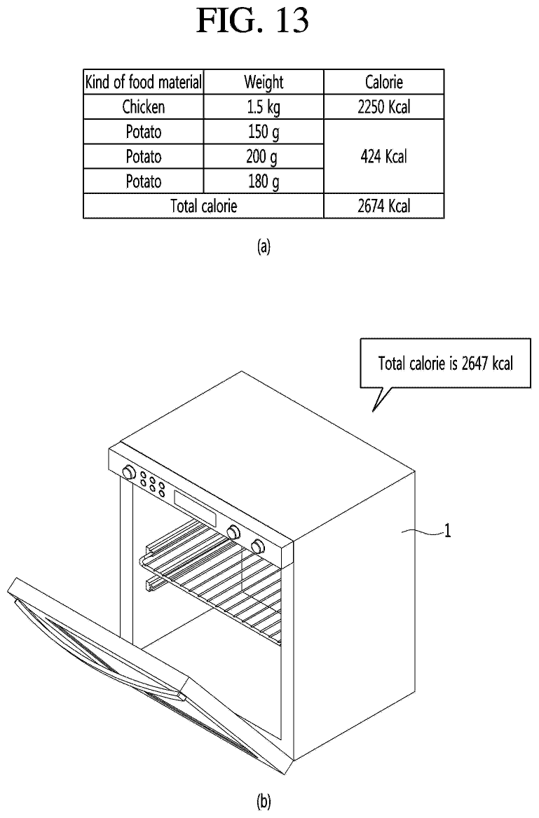

FIG. 13 is a view for explaining a method of calculating a total calorie of a first food material and a second food material according to an embodiment.

In the memory, a calorie per unit weight of the first food material and a calorie per unit weight of the second food material may be stored.

The processor may calculate a total calorie by using the kind and weight of the first food material and the kind and weight of the second food material.

Particularly, the processor may calculate a calorie of the photographed first food material on the basis of the kind and weight of the first food material and the calorie per unit weight of the first food material stored in the memory. For example, when the first food material is a chicken having a weight of 1.5 kg, and a calorie of the chicken is 150 kcal per 100 g, the processor may determine that the calorie of the photographed chicken is 2250 kcal.

Also, the processor may calculate a calorie of the photographed second food material on the basis of the kind and weight of the second food material and the calorie per unit weight of the second food material stored in the memory. For example, when the second food material is a potato, a weight of the potato is 530 g, and a calorie of the potato is 80 kcal per 100 g, the processor may determine that a calorie of the photographed chicken is 424 kcal.

Also, the processor may calculate a total calorie by adding the calorie of the first food material and the calorie of the second food material and output the calculated total calorie.

As described above, according to an embodiment, even when the different kinds of food materials are inputted to the cooking device at once, exact calorie information may be transferred to the user.

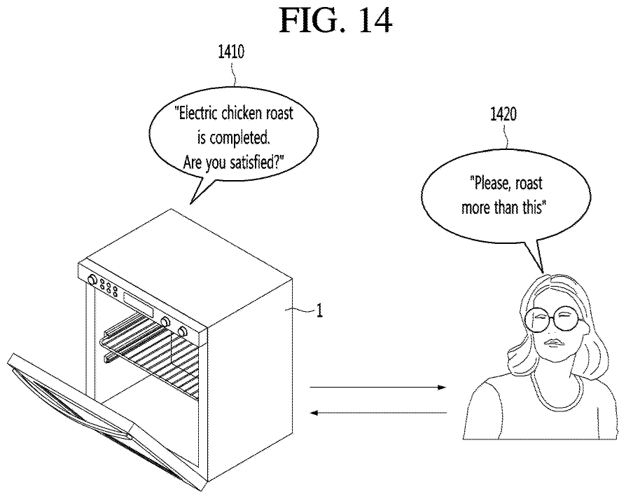

FIG. 14 is a view for explaining a method of modifying a cooking course according to an embodiment.

The processor may receive a user's feedback on a set cooking course.

Particularly, when a cooking is completed according to the set cooking course, the processor may output a feedback request 1410 for the user.

Also, the processor may receive a feedback 1420 from the user and modify the set cooking course on the basis of the feedback.

Particularly, when the user's feedback requests more heating, the processor may increase the cooking temperature or the cooking time of the set cooking course and then store the information.

Also, when the user's feedback requests less heating, the processor may decrease the cooking temperature or the cooking time of the set cooking course and then store the information.

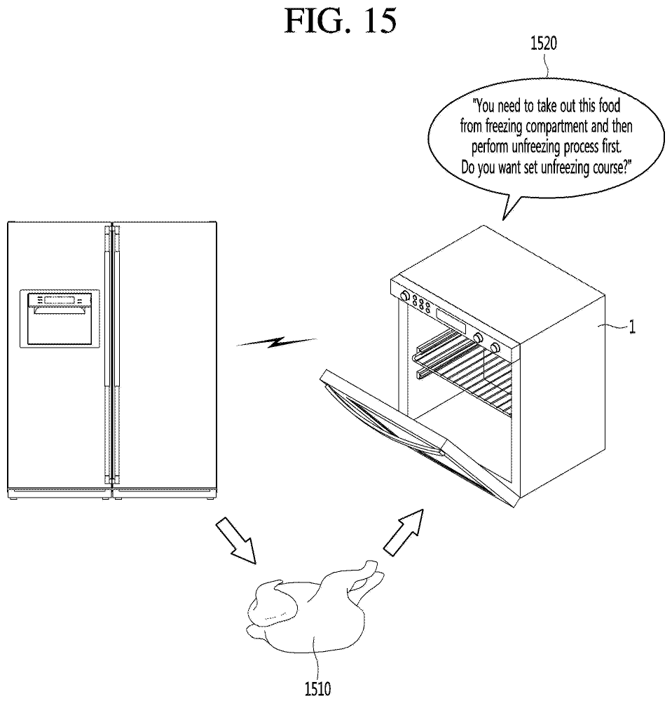

FIG. 15 is a view for explaining a connected operation with a refrigerator according to an embodiment.

The processor may communicate with a refrigerator through a communication unit.

Also, the processor may receive information on whether a food material 1510 is taken out from a cooling compartment or a freezing compartment.

Also, when an image including the food material 1510 taken out from the freezing compartment is photographed, the processor may output a notice 1520 of requesting unfreezing.

Also, the processor may set a unfreezing course and perform the unfreezing course when the food material is inputted.

Next, a method for operating the artificial intelligence cooking device will be described. The method for operating the artificial intelligence cooking device according to an embodiment includes: photographing at least one food material and detecting a distance to the at least one food material; acquiring a weight of the at least one food material by providing an image obtained by photographing the at least one food material and the distance to the artificial intelligence model; and performing a cooking according to a set cooking course on the basis of the kind and weight of the at least one food material. In this case, the artificial intelligence model may be a neural network that is trained by using training data including an image obtained by photographing a food material and a distance from which the image is photographed and labeling data including a weight of the food material.

The above-described embodiments may be realized as computer readable codes in a program recording medium. The computer readable medium includes all kinds of recording devices that store data which is able to be read by a computer system. For example, the computer readable medium includes a hard disk drive (HDD), a solid state disk (SSD), a silicon disk drive (SDD), ROM, RAM, CD-ROM, a magnetic tape, a floppy disk, and an optical data storage device. Also, the computer may include a control unit 180 of a terminal.

Therefore, the embodiments disclosed in the present disclosure are intended to illustrate rather than limit the technical idea of the present invention, and the scope of the technical idea of the present invention is not limited by these embodiments. The scope of protection of the present invention should be construed according to the following claims, and all technical ideas falling within the equivalent scope to the scope of protection should be construed as falling within the scope of the present invention.

What is claimed is:

1. An artificial intelligence cooking device comprising:
a sensor configured to photograph at least one food material and detect a distance to the at least one food material; and
a processor configured to acquire a weight of the at least one food material by providing an image obtained by photographing the at least one food material and the detected distance to an artificial intelligence model, and perform cooking according to a cooking course that is set on the basis of a kind of the at least one food material and the weight of the at least one food material,
wherein the artificial intelligence model is a neural network that is trained by using training data comprising an image obtained by photographing a food material and a distance from which an image is photographed and labeling data comprising a weight of a food material.

2. The artificial intelligence cooking device of claim 1, wherein the cooking course comprises at least one of a cooking temperature or a cooking time.

3. The artificial intelligence cooking device of claim 1, wherein the processor acquires a weight of a first food material and a weight of a second food material by providing an image obtained by photographing the first and second food materials and the detected distance to the artificial intelligence model, and set the cooking course by using a kind of the first food material, a weight of the first food material, a kind of the second food material, and a weight of the second food material.

4. The artificial intelligence cooking device of claim 3, wherein the processor acquires a first cooking course by using the kind of the first food material and the weight of the first food material and a second cooking course by using the kind of the second food material and the weight of the second food material.

5. The artificial intelligence cooking device of claim 4, wherein the processor performs cooking according to the first cooking course having a longer cooking time among the first cooking course and the second cooking course when the first cooking course and the second cooking course are different from each other.

6. The artificial intelligence cooking device of claim 4, wherein the processor outputs a notice when first cooking course and the second cooking course are different from each other.

7. The artificial intelligence cooking device of claim 4, wherein the processor outputs a notice of firstly inputting the first food material and performs cooking according to the first cooking course when a cooking time corresponding to the first cooking course is a first time and a cooking time corresponding to the second cooking course is a second time shorter than the first time, and outputs a notice of inputting the second food material when a remained cooking time according to the first cooking course is equal to the second time.

8. The artificial intelligence cooking device of claim 4, wherein the processor performs cooking according to the first cooking course when a cooking time corresponding to the first cooking course is a first time and a cooking time corresponding to the second cooking course is a second time shorter than the first time, and outputs a notice of removing the second food material when the second time elapses since the cooking is performed.

9. The artificial intelligence cooking device of claim 4, further comprising a memory configured to store a ratio between the first food material and the second food material,
wherein the processor outputs a notice of additionally inputting or removing one of the first food material or the second food material on the basis of the weight of the first food material, the weight of the second food material, and the ratio between the first food material and the second food material.

10. The artificial intelligence cooking device of claim 3, wherein the processor calculates a total calorie by using the kind of the first food material, the weight of the first food material, the kind of the second food material, and the weight of the second food material, and outputs the total calorie.

11. The artificial intelligence cooking device of claim 1, wherein the processor receives a user's feedback on the set cooking course and corrects the set cooking course on the basis of the feedback.

12. A method for operating an artificial intelligence cooking device, comprising:
photographing at least one food material and detecting a distance to the at least one food material;
acquiring a weight of the at least one food material by providing an image obtained by photographing the at least one food material and the detected distance to an artificial intelligence model; and
performing cooking according to a cooking course that is set on the basis of a kind of the at least one food material and the weight of the at least one food material,
wherein the artificial intelligence model is a neural network that is trained by using training data comprising an image obtained by photographing a food material and a distance from which an image is photographed and labeling data comprising a weight of a food material.
